(19) United States
(12) Patent Application Publication
(10) Pub. No.: US 2009/0005893 A1
(43) Pub. Date: Jan. 1, 2009

(54) CONTENTS DISTRIBUTION SYSTEM AND CENTER UNIT

(75) Inventors: KIYOHISA SUGII, HAMAMATSU-SHI (JP); YOUJI SEMBA, HAMAMATSU-SHI (JP)

Correspondence Address: CROWELL & MORING LLP;INTELLECTUAL PROPERTY GROUP, P.O. BOX 14300, WASHINGTON, DC, 20044-4300, US

(73) Assignee: YAMAHA CORPORATION, Hamamatsu-shi (JP)

(21) Appl. No.: 12/163,710

(22) Filed: Jun. 27, 2008

(30) Foreign Application Priority Data
Jun. 29, 2007 (JP) 2007-173415

(51) Int. Cl. G06F 17/00

(52) U.S. Cl. 700/94

(57) ABSTRACT

A computer transmits to a center unit request data showing correspondence among a time zone, a music-genre, and a location in a store. Upon receipt of the request data, the center unit updates specifics of a contents distribution management table on the basis of the received request data. On the basis of specifics of the table, contents corresponding to a time zone and an address of a destination are distributed to respective speaker terminals through streaming distribution. At this time, when a genre of contents is specified by means of the request data, the center unit selects contents specified for sales promotion by reference to a music use condition table and distributes the selected contents to the speaker terminal.

### BACKGROUND OF THE INVENTION

The present invention relates to a technique for distributing contents.

Background music (hereinafter BGM) is generally played in stores, such as restaurants and boutiques, by means of wire broadcasting. Further, a BGM terminal device capable of playing BGM in accordance with a program prepared by a user is proposed in; for example, JP-A-9-247105. The device can play BGM in accordance with a program prepared by the user.

Incidentally, in order to promote sale of contents, companies that sale contents, such as music, perform various sales promotion business activities for broadcast stations, and the like. Such business activities for sales promotion often involve consumption of much efforts and time. This is not limited to music, and the same also applies to a video, a game program, and the like.

### SUMMARY OF THE INVENTION

The present invention has been conceived in view of the circumstances and aims at providing a technique for enabling a contents sales company, or the like, to promote sale of contents with smaller amounts of efforts than those involved in the related art.

In order to achieve the object, the present invention provides the following arrangements.

(1) A contents distribution system comprising:

a center unit; and

a plurality of contents reproducing terminals communicating with the center unit,

wherein the center unit includes:
a memory that stores contents identifying information for identifying contents and promotion information showing whether or not to promote reproducing of contents while the contents identifying information is associated with the promotion information;
a request data receiver that receives request data showing a request for distribution of contents to the contents reproducing terminal;
a distribution contents selector that, when the received request data shows a request for distribution of contents promoted by reproducing, selects one or a plurality of contents showing that the corresponding promotion information promotes reproducing of contents, with reference to the memory; and
a contents distributor that reads the one or the plurality of selected contents from a predetermined storage device and distributes the read contents to the contents reproducing terminal corresponding to the received request data, and

wherein the contents reproducing terminal includes:
a contents receiver that receiving contents distributed from the center unit by the contents distributor; and
a reproducing unit that reproduces contents received from the contents receiver.
   (2) The contents distribution system according to (1), wherein the contents receiver receives contents transmitted from the center unit by extracting a signal superimposed on electric power transmitted by way of a power line.
   (3) A center unit comprising:

a memory that stores contents identifying information for identifying contents and promotion information showing whether or not reproducing of the contents is promoted while the contents identifying information is associated with the promotion information;

a request data receiver that receives request data showing request for distribution of contents to a contents reproducing terminal;

a distribution contents selector that, when the received request data show a request for distribution of contents for promoting by reproducing, selects one or a plurality of contents showing that corresponding promotion information promotes reproducing of contents, with reference to the memory; and

a contents distributor that reads from a predetermined storage device one or a plurality of selected contents from a predetermined storage device and distributes the read contents to a contents reproducing terminal corresponding to the received request data.

(4) The center unit according to (3), further comprising:

a charge controller that subjects contents distributed by the contents distributor to charging operation at amounts corresponding to the respective contents.

(5) The center unit according to (4), wherein

the memory stores one or a plurality of groups, each group including one or a plurality of contents, and

the center unit further comprises a determination unit that determines whether or not the received request data shows a request for distribution of contents belonging to the groups; and

the charge controller performs charging corresponding to a predetermined charging condition individually set for the respective groups when a result of determination made by the determination unit is affirmative.

(6) The center unit according to (4), wherein

the charge controller includes:
a first charging unit that performs processing for charging for the contents in accordance with a first charging system; and
a second charging unit that performs processing for charging for the contents in accordance with a second charging system which is cheaper in charge than the first charging system, and

charging operation is performed by use of the second charging unit when promotion information corresponding to contents which are objects of computation of a charge shows promotion of reproducing, and charging operation is performed by use of the first charging unit in other cases.

(7) The center unit according to (3), wherein, when the received request data show a predetermined selection condition, the distribution contents selector selects contents satisfying the selection condition with reference to the memory in such a manner that the number of contents corresponding to promotion information showing promotion by reproducing becomes greater than the number of other contents.
(8) The center unit according to (7), wherein the selection condition indicates at least any one of a type of genre, a creator of a contents, a name of a singer, and a group to which a contents belongs.
(9) The center unit according to (3), further comprising:

a reader that reads contents identifying information showing that corresponding promotion information promotes reproducing of a contents, with reference to the memory; and

a notification unit that notifies contents indicated by the contents identifying information read by the reader.

(10) A center unit comprising:

a memory that stores contents identifying information for identifying contents and promotion information showing whether or not reproducing of contents is promoted while the contents identifying information is associated with the promotion information;

a request data receiver that receives request data showing a request for distribution of contents to the contents reproducing terminal;

a distribution contents selector that, when the received request data shows a predetermined condition for selection, selects contents corresponding the promotion information showing promotion of reproducing, with reference to the memory; and

a contents distributor that reads the selected contents from a predetermined storage device and distributes the read contents to a contents reproducing terminal corresponding to the received request data.

(11) The center unit according to (10), wherein, when the received request data show the predetermined selection condition, the distribution contents selector selects contents satisfying the selection condition with reference to the memory in such a manner that the number of contents corresponding to promotion information showing promotion by reproducing becomes greater than the number of other contents.
(12) The center unit according to (10), wherein the selection condition indicates at least any one of a type of genre, a creator of a contents, a name of a singer, and a group to which a contents belongs.
(13) The center unit according to (10), further comprising:

a reader that reads contents identifying information showing that corresponding promotion information promotes reproducing of a contents, with reference to the memory; and

a notification unit that notifies contents indicated by the contents identifying information read by the reader.

According to the present invention, a contents sales company, or the like, can promote sale of contents with smaller amounts of efforts than those involved in the related art.

### BRIEF DESCRIPTION OF THE DRAWINGS

FIG. 1 is a block diagram showing an example configuration of a system;

FIG. 2 is a view showing an example mode of arrangement of speaker terminals 10 in a store 100;

FIG. 3 is a view showing an example configuration of the speaker terminal 10;

FIG. 4 is a view showing an example configuration of a center unit 40;

FIG. 5 is a view showing an example of specifics of a speaker address management table;

FIG. 6 is a view showing an example of specifics of a contents distribution management table;

FIG. 7 is a view showing an example of specifics of a music use condition table; and

FIG. 8 is a view showing an example of specifics of request data.

### DETAILED DESCRIPTION OF PREFERRED EMBODIMENTS

### <A: Configuration of Contents Distribution System>

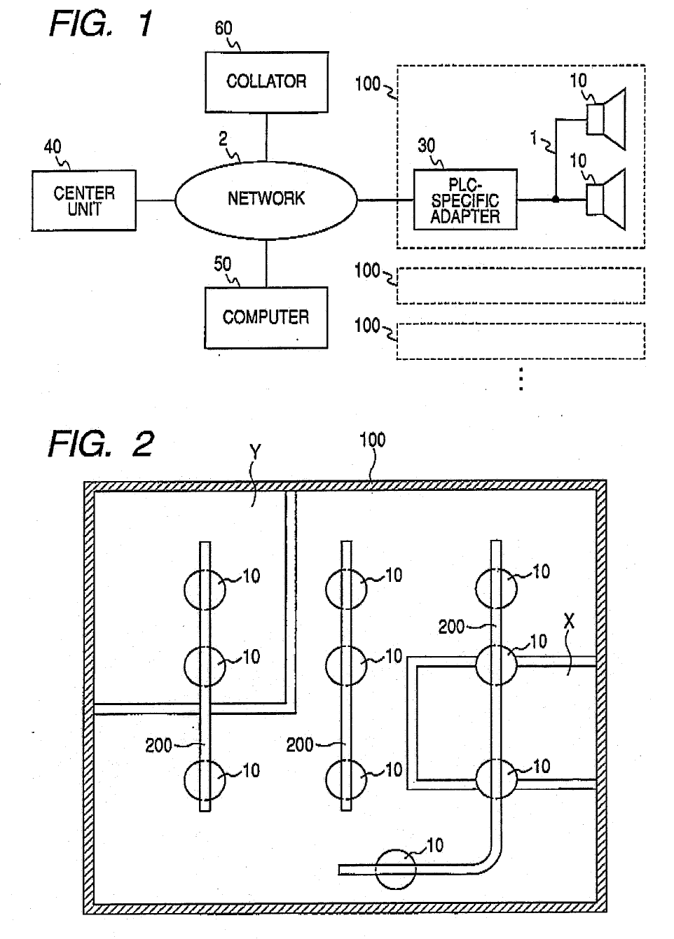

First, a contents distribution system of the present invention will be described by reference to FIG. 1. In the drawings, stores 100 are; for instance, restaurants, boutiques, and the like, and set up at many locations in the country. Each of the stores 100 has speaker terminals 10 and a PLC-specific adapter 30. In order to prevent complication of a drawing, the speaker terminals 10 and the PLC-specific adapter 30 installed in only one storage 100 are illustrated in FIG. 1. However, the speaker terminals 10 and the PLC-specific adapter 30 are likewise installed in each of the other stores 100. The PLC-specific adapter 30 and the speaker terminals 10 are connected together by way of a power line 1.

The speaker terminals 10 are contents reproducing terminals having a function of producing sound in accordance with supplied audio data. The PLC-specific adapter 30 is for transmitting data by way of the power line 1 under a PLC (Power Line Communication) scheme. The PLC-specific adapter 30 superimposes a signal showing data received through a network 2 on commercial power and transmits the signal to the speaker terminals 10 through the power line 1. Further, the PLC-specific adapter 30 extracts the signal superimposed on the power transmitted through the power line 1 and transmits the signal to a center unit 40 by way of the network 2. The center unit 40 is for providing the stores 100 with audio data, such as music. The center unit 40 and the PLC-specific adapter 30 are communicably connected together by way of the network 2, such as the Internet or a private line; and the center unit 40 supplies audio data to the respective speaker terminals 10 by way of the network 2, the PLC-specific adapter 30, and the power line 1. A computer 50 is; for example, a personal computer, and for requesting the nature of music to be played in the store 100 or registering contents, such as audio data, in the center unit 40. The computer 50 acts also as a device by means of which a copyright holder or a sales person of a record company makes various settings for promoting sale. The computer 50 may also be set in each of the stores 100 or in a maintenance facility that controls the stores 100. The location where the computer 50 is to be set is arbitrary.

A collator 60 has a database capable of downloading basic information about music, such as the title of music, the name of a category of music, the name of an artist, and the title of an album. Basic information (hereinafter called “label data”) about music and collation data used for identifying a waveform of an audio signal of music are stored in an associated manner in the database of the collator 60. In the present embodiment, sound fingerprint information generated by use of a technique called MusicID proposed by Gracenote is used as collation data. The collator 60 collates verification data received from another device with verification data stored in the database, to thus specify contents, and transmits label data pertaining to the thus-specified contents to the device.

An example mode of installation of the speaker terminals 10 in the store 100 will now be described by reference to FIG. 2. In FIG. 2, the store 100 has a plurality of selling sections, such as a selling section X and a selling section Y, and one or a plurality of speaker terminals 10 are installed in each of the selling sections. The speaker terminals 10 are attached to a power supply rail 200 that supplies electric power, and sections of the speaker terminals 10 are driven by means of electric power supplied from the power supply rail 200. An IP address is allocated to each of the speaker terminals 10. Each speaker terminal 10 has a function of receiving audio data supplied under the PLC scheme and generates sound in accordance with audio data received through the power line 1.

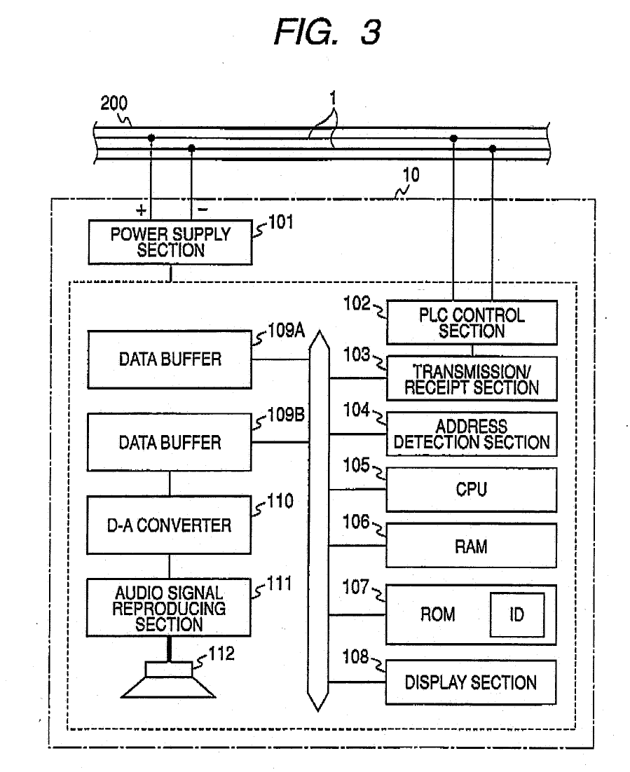

An example configuration of the speaker terminal 10 will now be described by reference to FIG. 3. FIG. 3 is a block diagram showing an example configuration of the speaker terminal 10. A power source section 101 converts AC electric power of a commercial frequency into DC electric power. The thus-converted DC electric power is supplied to respective sections of the speaker terminal 10. A PLC control section 102 extracts a signal from the AC electric power and superimposes a signal supplied from a transmission-receipt section 103 on electric power. An address detection section 104 detects an address of the data received by the transmission-receipt section 103. A CPU 105 reads various programs stored in ROM 107 and executes the thus-read program. RAM 106 is used as a work area for the CPU 105 and temporarily stores the program executed by the CPU 105 or various data. An ID used for identifying a terminal per-se is stored in the ROM 107. In the present embodiment, an IP address is used as an ID for identifying a terminal. Although an IP address is used as an ID for identifying the speaker terminal 10 in the present embodiment, identification information used as an ID is not limited to the IP address, and any information may also be used, so long as the information identifies the speaker terminal 10. A display section 108 is; for instance, a liquid-crystal display, and displays various images under control of the CPU 105.

Data buffers 109A and 109B are memory means for temporarily storing data transmitted through the power line 1. The address detection section 104 determines whether or not an address of audio data transmitted through the power line 1 coincides with an IP address (ID) allocated to the terminal per-se, and outputs coincident data to the data buffer 109A. Further, the CPU 105 determines whether or not the label data are imparted to contents stored in the data buffer 109A, and transfers the contents given the label data to the data buffer 109B. Meanwhile, the CPU 105 discards contents not imparted with label data.

A D-A (digital-to-analogue) converter 110 converts digital data stored in the data buffer 109B into an analogue signal. An audio signal reproducing section 111 amplifies an analogue signal output from the D-A converter 110 and supplies the signal to a speaker 112, thereby driving the speaker 112. The speaker 112 is sound generation means that generates sound in accordance with the analogue signal supplied from the audio signal reproducing section 111.

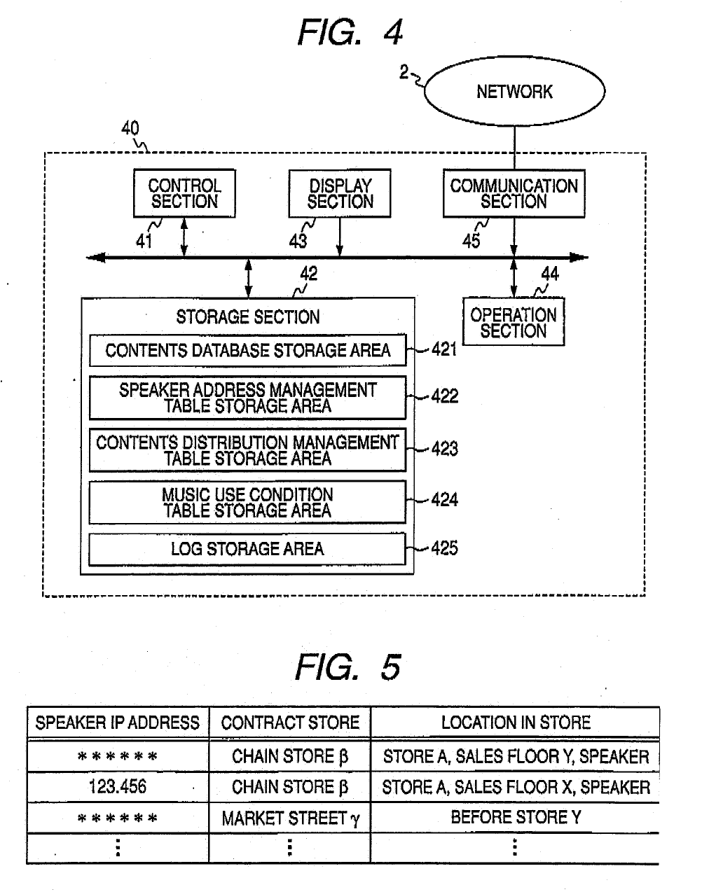

A configuration of a center unit 40 will now be described by reference to FIG. 4. FIG. 4 is a block diagram showing the configuration of the center unit 40. In the drawing, the control section 41 has the CPU, the ROM, and the RAM and reads and executes a computer program stored in the ROM or a storage section 42, thereby controlling respective sections of the center unit 40 by way of a bus. The storage section 42 is storage means for storing a computer program to be executed by the control section 41 or data used at the time of execution of the program; for instance, a hard disk drive. In particular, in the present embodiment, the storage section 42 acts as contents storage device for storing a plurality of contents. A display section 43 has a liquid-crystal display and displays a menu screen, or the like, for operating the center unit 40 under control of the control section 41. An operation section 44 outputs an operation signal responsive to user's operation to the control section 41. A communications section 45 is communications means having; for example, a modem, and establishes communication with the speaker terminals 10 through the network 2, the PLC-specific adapter 30, and the power line 1.

As illustrated, the storage section 42 has a contents database storage area 421; a speaker address management table storage area 422; a contents distribution management table storage area 423; a music use condition table storage area 424; and a log storage area 425. A plurality of pieces of audio data representing audio, such as music, are stored in the contents database storage area 421. In the following descriptions, an explanation is provided while audio data stored in the contents database storage area 421 are referred to as contents for the sake of description. Each of contents is assigned genre identification information for identifying a genre of contents as well as a contents ID for identifying contents. The word “audio” used herein includes various acoustics, such as voice produced by a person and musical sound generated by music instruments. The control section 41 of the center unit 40 distributes contents (audio data) stored in the contents database storage area 421 to the speaker terminals 10 set in the respective stores 100 by means of streaming.

A speaker address management table for managing IP addresses of the speaker terminals 10 is stored in the speaker address management table storage area 422 of the storage section 42. FIG. 5 is a view showing example specifics of the speaker address management table. As illustrated, a plurality of records whose items “Speaker IP Address,” “Contract Store,” and “Location in Store” are associated with each other are stored in the table. Of these items, IP addresses allocated to the respective speaker terminals 10 are stored in the item “Speaker IPAddress.” Data indicating the designation of a contract store that manages the speaker terminal 10 are stored in the item “Contract Store.” Data indicating the designation of the store 100 where the speaker terminal 10 is installed and data showing a location where the speaker terminal 10 is installed in the store 100 are stored in the item “Location in Store.” A manager of the store 100 performs operation for registering into the center unit 40 data showing an allocated IP address, a contract store, and a location in the store where the speaker is installed in connection with each of the speaker terminals 10 installed in the store 100, by use of; for instance, the computer 50 or the like. In this case, the computer 50 transmits data conforming to the performed operation to the center unit 40, and the center unit 40 registers the data received from the computer 50 into the speaker address management table.

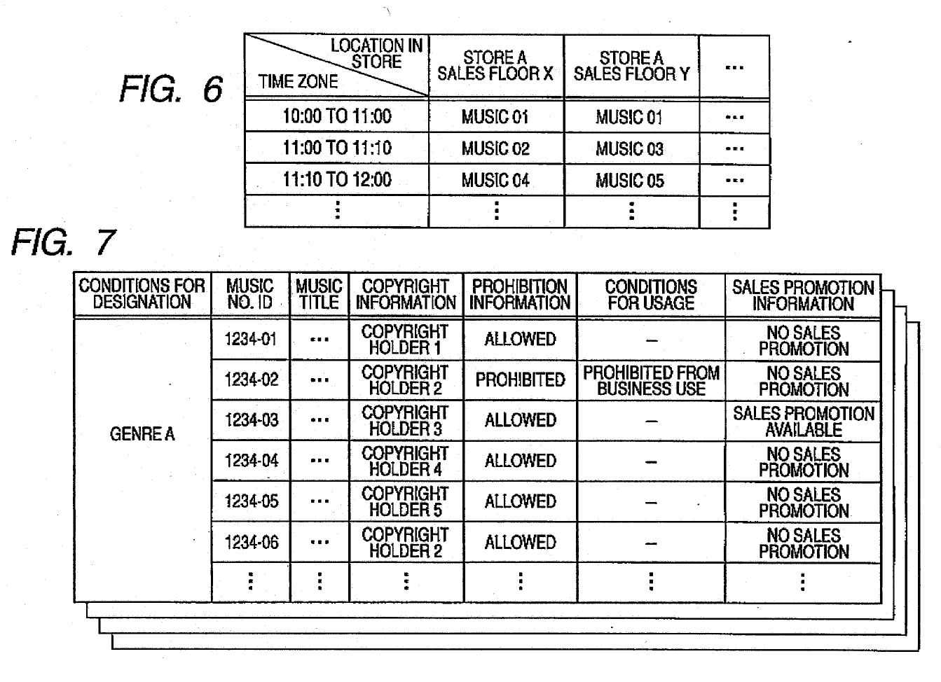

Contents distribution management tables for managing distribution conditions of contents to the respective speaker terminals 10 are stored in the contents distribution management table storage area 423. FIG. 6 is a view showing example specifics of the contents distribution management table. A plurality of tables where items “Time Zone” and “Location in Store” are associated with each other are stored on a per-store basis in the storage area. Information showing a time zone is stored in the item “Time Zone” of the items. Information showing a location in the store 100, where the speaker terminal 10 serving as a destination of distribution of contents is installed, is stored in the item “Location in Store.” Contents identifying information for identifying contents to be played at a designated location and in a designated time zone and attribute information showing a genre to which the contents belong are stored in each of cells of the table. The attribute information is information including; for example, “Genre A,” “Singer b,” “New Music,” “Best Music,” and the like. In accordance with specifics of the table, the center unit 40 distributes contents to the respective speaker terminals 10.

The contents distribution management table is managed on a per-store basis. In accordance with specifics of the contents distribution management table, the control section 41 distributes contents to the speaker terminals 10 in the store 100 from the center unit 40 through streaming operation.

A plurality of music use condition tables for setting conditions for usage of contents are stored for each “Designated Condition” in the music use condition table storage area 424. FIG. 7 is a view showing example specifics of the music use condition table. For instance, a plurality of music use condition tables for various designated conditions; for example, “Genre A,” “Genre B,” . . . , “Singer a,” “Singer b,” . . . , “New Music,” . . . “Best Music,” are stored in the music use condition table storage area 424. As illustrated, a plurality of records whose items “Music Number ID,” “Music Title,” “Copyright Information,” “Prohibition Information,” “Use Condition,” and “Sales Information” are associated with each other are stored in the music use condition table. Identifying information for identifying contents; for example, a music code, is stored in the item “Music Number ID” of the items. Text data showing the designation of contents are stored in the item “Music Title.” Text data showing the copyright holder of the contents are stored in the item “Copyright Information.” Data showing whether or not to allow (allow or prohibit) reproducing of contents in the public are stored in the item “Prohibition Information.” Data showing whether or not contents are objects of sales promotion (“No Sales Promotion” or “Sales Promotion is Intended”) are stored in the item “Sales Promotion Information.” In the present embodiment, when distribution of contents is requested by an ambiguous designation method; for example, a genre, the control section 41 of the center unit 40 makes a reference to the “Sales Promotion Information” in the respective records of this table by reference to the designation condition table, thereby determining contents to be distributed.

Log data pertaining to distribution, such as the title of distributed contents, a store that is a destination, a speaker ID allocated to the speaker terminal 10 serving as a destination of distribution, and the like, are stored in the log storage area 425.

The configuration of the computer 50 will now be described. The computer 50 has a control section, a storage section, a display section, an operation section, a communications section, and the like, and has a function of transmitting data conforming to specifics of performed operation to the center unit 40. Configurations of the respective sections of the computer 50 are the same as those of the center unit 40, and their detailed explanations are omitted.

The configuration of the collator 60 will now be described. The collator 60 has a control section, a storage section, a display section, an operation section, a communications section, and the like. The storage section of the collator 60 has a collation database. A plurality of records whose items “Collation Data” and “Label Data” are associated with each other are stored in the collation database. Collation data acquired by analysis of some or entirety of contents are stored in the item “Collation Data” of the items. Next, label data showing basic information about contents, such as the title of music contents, the designation of a genre, the name of an artist, and the title of an album, are stored in the item “Label Data.” The collator 60 collates collation data received from another device with collation data stored in the collation database, thereby specifying contents in accordance with the degree of a match; and transmits label data pertaining to the specified contents to the device as a response to the received collation data.

### <B: Operation>

Operation of the contents distribution system of the present embodiment will now be described.

### <B-1: Operation for Registering Contents>

First, operation of the system for registering contents will be described. In the present embodiment, the manager of the store 100, a copyright holder of contents, and a sales person of a record company (hereinafter called a “contents registration person”) can register contents in the contents database by use of the computer 50. The contents registration person operates the operation section of the computer 50, to thus perform operation for requesting registration of contents. The operation section outputs an operation signal conforming to specifics of performed operation to the control section. In accordance with the operation signal supplied from the operation section, the control section transmits contents to the center unit 40.

Upon receipt of contents from the computer 50, the center unit 40 analyzes some or entirety of received contents, to thus generate collation data. The center unit 40 transmits the thus-generated collation data to the collator 60. The collator 60 specifies contents by use of the collation data received from the center unit 40 and transmits label data pertaining to the specified contents to the center unit 40 as a response to the received collation data. At this time, when the received collation data are not registered in the database and when data matching the received collation data are not retrieved, the collator 60 transmits to the center unit 40 data to that effect. In relation to this processing operation, for instance, label data indicating that data matching received collation data are not searched may also be generated and transmitted to the center unit 40.

The center unit 40 receives the label data transmitted from the collator 60 as a response to the transmitted collation data. The control section 41 of the center unit 40 determines whether or not the contents received from the computer 50 are assigned label data. When the contents are determined not to be assigned label data, the center unit 40 adds the label data received from the collator 60 to the contents received from the computer 50, and stores the contents additionally provided with the label data into the contents database storage area 421. Meanwhile, when the contents received from the computer 50 are determined to be additionally provided with label data, the control section 41 updates the label data received from the collator 60 by means of the label data added to the contents; and stores the contents having the updated label data into the contents database storage area 421.

### <B-2: Registration Operation for Music Use Condition Table>

Registration operation for the music use condition table will now be described. A copyright holder of contents and a sales person of a record company operate the operation section of the computer 50, to thus register conditions for usage of respective contents into the music use condition table. At this time, the copyright holder of contents and the sales person of a record company transmits to the center unit 40 data pertaining to a record for which values are set in connection with the items shown in FIG. 7. Specifically, when performance of sales promotion of contents whose music number ID is “1234-03” is desired, the sales person of the record company sets a value indicating “Sales Promotion is Intended” in the item “Sales Promotion Information” about the record assigned the music number ID “1234-03” and transmits the data to the center unit 40. Upon receipt of the data from the computer 50, the center unit 40 registers conditions for usage of respective contents into the music use condition table in accordance with the received data. When contents are distributed, a reference is made to the thus-set conditions for usage of respective contents. In particular, in the present embodiment, when distribution of contents is requested by means of an ambiguous designation method, such as a genre or when distribution of contents designated for sales promotion (“Sales Promotion is Intended” is set in the item “Sales Promotion Information” of the music use condition table) is requested, the control section 41 selects one or a plurality of contents whose corresponding sales promotion information is “Sales Promotion is Intended” by reference to the table, and distributes the thus-selected contents to the speaker terminal 10 through streaming distribution.

### <B-3: Registration Operation for Contents Distribution Management Table>

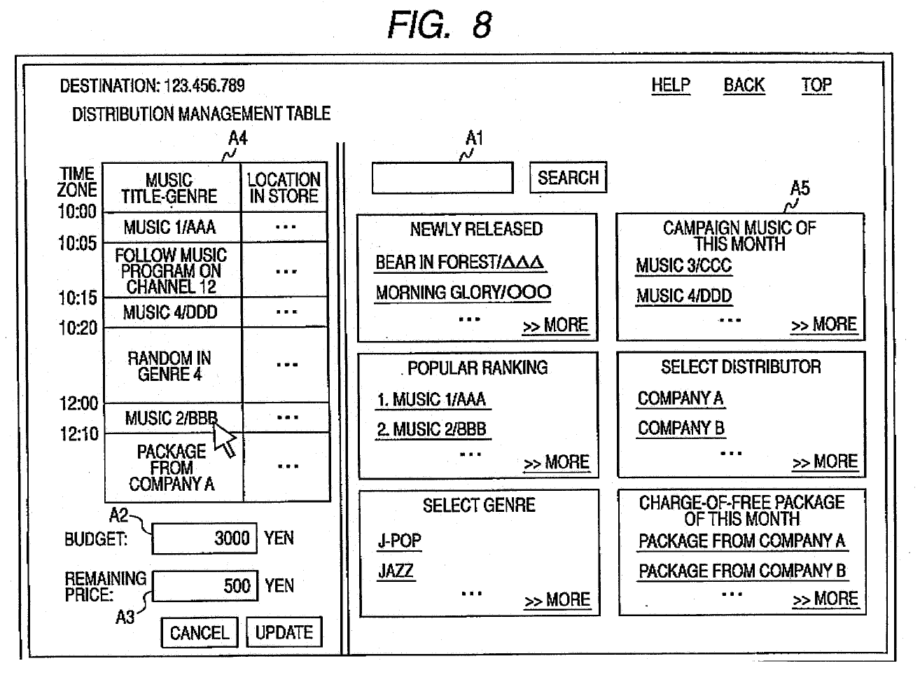

Registration operation for the contents distribution management table will now be described. The manager of the store 100 operates the operation section of the computer 50 and transmits data (e.g., an HTTP request) used for registering which of the speaker terminals 10 and the nature of music to be played. The data include a store ID, or the like, for specifying a store. The center unit 40 transmits to the computer 50 data (e.g., an HTTP response) for displaying a screen illustrated in FIG. 8 as a response to the data received from the computer 50. Prior to transmission of the data, the computer 50 may also be caused to display a screen for prompting entry of a user ID and a password, to thus authenticate the user by means of the user ID and the password input by the manager. In accordance with the data received from the center unit 40, the computer 50 displays a screen illustrated in FIG. 8 on the display section.

FIG. 8 shows an example screen displayed on the display section of the computer 50. A screen shown in FIG. 8 is displayed for each store 100 or for each speaker terminal 10. In the screen shown in FIG. 8, a table A4 for managing contents to be distributed is displayed on the left side of the screen. The table is configured in such a way that the items “Time Zone,” “Music Title-Genre,” and “Location in Store” are associated with each other as illustrated. Information showing a time zone during which contents are distributed; for example, “10:00 to 10:05” is stored in the item “Time Zone” of the items. Information showing the designation of contents; for example, “Music 1” and “Jazz,” and information showing a genre of contents are stored in the item “Music Title-Genre.” Data showing a location where a speaker terminal 10 serving as a destination is installed; for example, “Whole of Building” or “Sales Floor A,” are stored in the item “Location in Store.”

A search box A1 for searching contents and a list A5 including titles of contents and genres are displayed on the right side of the screen shown in FIG. 8. The manager of the store 100 can search contents by use of the operation section and the search box A1 and perform drag-and-drop operation of the title of contents displayed in the display section to the table on the left side of the drawing. A program (a program guide) of contents to be distributed is created as a result of the contents being stored in the table through performance of the operations.

When the manager of the store 100 performs the operation section, to thus set specifics of the table and click an “update” button, the operation section of the computer 50 outputs to the control section an operation signal conforming to specifics of the operation performed by the manager of the store 100. In response to the signal supplied from the operation section, the control section of the computer 50 generates request data showing specifics of the distribution management table, and transmits the thus-generated request data to the center unit 40 by way of the communications section 45.

Upon receipt of the request data from the computer 50, the center unit 40 updates the specifics of the contents distribution management table in accordance with the specifics of the received request data. As a result of the manger of each store 100 operating the computer 50, to thus transmit request data, data showing contents to be distributed to the respective speaker terminals 10 installed in the respective stores 100 are stored in the contents distribution management table of the center unit 40.

On the screen illustrated in FIG. 8, contents displayed in a box “Campaign Music of This Month” are contents (hereinafter called “Sales Promotion Contents”) for which a sales person of a record company, or the like, has set promotion of sale (“Sales Promotion is Intended” is set in the “Sales Promotion Information” in the music use condition table) and set such that the contents can be used for a charge cheaper than a normal charge. The control section 41 of the center unit 40 determines whether or not the received request data show a request for distribution of contents belonging to the group “Campaign Music.” When a result of determination is affirmative, charging complying with predetermined conditions set for the group is performed.

In FIG. 8, contents displayed in the box “Pack of This Month” correspond to a pack of contents that can be distributed for free when predetermined conditions are fulfilled. Various conditions are set for each pack; for example, when three or more music contents supplied by A Corporation are purchased, a pack of contents included in “Pack of A Corporation” can be distributed for free. The control section 41 determines whether or not received request data showing a request for distribution of contents belonging to the group. When a result of determination is affirmative, an additional determination is made as to whether or not predetermined conditions (for instance, whether or not three or more contents supplied by A Corporation have been purchased, or the like) are fulfilled. When a determination result is affirmative, a charge resultant from distribution of contents belonging to the group is made free. In the present embodiment, all contents belonging to a pack can be distributed for free. However, the present invention is not limited to the embodiment. For instance, some of contents included in a pack may also be distributed for free. Thus, contents for sales promotion included in a pack may also be a part or the entirety of the pack.

As illustrated in FIG. 8, the control section 41 may also be arranged so as to display, on a screen, a text box A2 by means of which the operator inputs a budget and a residual cost A3. In this case, the control section 41 may also compute a total of usage charges of contents registered in the distribution management table; compute a residual cost by subtracting the computed usage charge from the amount of money input into the text box A2; and display a computed residual cost A3.

### <B-4: Contents Distribution Operation>

Operation of the system for distributing contents will now be described. The center unit 40 distributes contents to the respective speaker terminals 10 on the basis of specifics of the contents distribution management table. Specifically, the center unit 40 reads, on the basis of specifics of the request data received from the computer 50, contents corresponding to respective time zones from the contents database storage area 421; and distributes the thus-read contents to an IP address designated by the request data through streaming distribution.

At this time, when the title of music (the title of contents) is designated on the contents distribution management table, the control section 41 distributes the thus-designated contents through streaming distribution. Specifically, for instance, when specifics of the distribution management table are those shown in FIG. 6, contents of “Music 01” are distributed to the speaker terminal 10 in the “Sales Floor X in Store A” in a time zone “10:00 to 11:00.” In a time zone “11:00 to 11:10,” contents of “Music 02” are distributed. Thus, contents of a genre or contents designated by request data are distributed to the respective speaker terminal 10 in respective time zones. At this time, when the contents are designated, the control section 41 of the center unit 40 searches designated contents from the contents database and distributes the searched contents through streaming distribution.

When the title of contents is not specified in the contents distribution management table; for example, when conditions for selection of contents (a genre, the name of a singer, and the like) are specified, the control section 41 selects, by reference to a music use condition table corresponding to designated conditions for selection, contents distributed by reference to sales promotion information or prohibition information stored in the music use condition table for which a reference has been made; and distributes the thus-selected contents to the speaker terminal 10 by means of the store ID through streaming operation. The control section 41 selects a sales promotion contents, for which “Sales Promotion Available” is set in relation to “Sales Promotion Information,” in preference to the other contents in the music use condition table. Specifically, when the received request data show predetermined conditions for selection (a genre, the name of a singer, a new song, a best song, and the like), the control section 41 determines whether or not sales promotion contents are registered in the music use condition table corresponding to the conditions for selection. When the sales promotion contents are registered, the registered sales promotion contents are selected by priority. In the meanwhile, when the sales promotion contents are not registered in the table, contents registered in the table are selected. Specifically, for instance, when request data are data showing a request for distribution of contents of five pieces of music belonging to a genre “Jazz” and when sales promotion contents of three pieces of music are registered in the music use condition table corresponding to “Jazz,” the control section 41 selects the contents of three pieces of music, for which the item “Sales Promotion Information” in the table is set to “Sales Promotion Available,” in preference to the other contents, by reference to a table whose “Conditions for Designation” is “Jazz” among the music use condition tables stored in the music use condition table storage area 424, and selects two musical components from the contents other than the sales promotion contents.

When the number of sales promotion contents registered in the music use condition table is larger than the number of contents requested for distribution, the control section 41 may select one or a plurality of contents from the plurality of contents by use of a predetermined algorithm. The selection method may be embodied by means of; for example, randomly selecting one or a plurality of contents from the plurality of contents or sequentially selecting contents from high-level records in the table. Alternatively, the method may also be embodied by means of storing; for example, a value showing the level of sales promotion in the item “Sales Promotion Information” of the music use condition table shown in FIG. 7 and sequentially selecting contents exhibiting higher levels of sales promotion by reference to the sales promotion level. Thus, the selection method can be changed in accordance with a design or the like. When received request data show predetermined conditions for selection, the control section 41 may also select contents from a music use condition table corresponding to the conditions for selection in such a way that the number of sales promotion contents becomes greater than the number of other contents. When the contents distribution management table includes a designation “Ignore Sales Promotion,” hit music in a genre or popular request music may also be selected.

When distributing contents, the center unit 40 stores the title of contents, a store serving as a destination, and a speaker ID of a speaker terminal 10 installed at a destination, and the like, as logs in a log storage area 425. At that time, when distributed contents are sales promotion contents, the center unit 40 leaves a log showing “Discount music, Free-of-charge music” along with the title of contents.

Operation of the speaker terminal 10 that receives contents distributed from the center unit 40 will now be described. Respective sections of the speaker terminal 10 are driven by electric power supplied from the power supply rail 200. An address detection section 104 of the speaker terminal 10 detects a destination address of data transmitted through the power supply rail 200; and supplies the data buffer 109A with data whose destination address is an IP address allocated to the speaker terminal itself. Thus, the speaker terminal 10 receives the contents distributed from the center unit 40 through streaming distribution. The CPU 105 determines whether or not the contents stored in the data buffer 109A are affixed with label data and transfers the contents affixed with the label data to the data buffer 109B. A D-A converter 110 converts the data stored in the data buffer 109B into an analogue signal and supplies the thus-converted analogue signal to the audio signal reproducing section 111. The audio signal reproducing section 111 amplifies the audio signal by a predetermined level and supplies the thus-amplified audio signal to a speaker 112. The speaker 112 emits a sound in accordance with the supplied audio signal. Thereby, sound representing the contents distributed from the center unit 40 to the speaker terminal 10 are generated.

In the present embodiment, the user can distribute desired contents by means of a simple configuration, and unauthorized reproducing of the contents can be prevented. Further, sale of contents can be promoted by use of the same system. More specifically, in the present embodiment, a copyright holder or a record company previously registers contents desired to be reproduced by priority into the music use condition table storage area 424 of the center unit 40. When a client makes a request under ambiguous conditions (designation of a genre or the like), the center unit 40 selects and distributes contents registered in the music use condition table. In this case, music of sales promotion contents is automatically selected and reproduced by priority, so long as the record company sets conditions for performance to a low level in connection with the sales promotion contents. A contents sales company, or the like, can promote contents with effort lesser than that consumed in the related art. In the present embodiment, the user can get an advantage of the ability to reduce a charge as a result of charge for sales promotion contents being set free or set to a low price. Therefore, the user can play BGM at low price.

### <C: Modification>

The embodiment of the present invention has been described above. However, the present invention is not limited to the foregoing embodiment and can be implemented in various other forms. Examples of the forms are provided below. Modes provided below may also be combined, as required.

(1) In the foregoing embodiment, data representing audio of music serving as contents are used. However, the contents are not limited to such data. In addition to being musical data, the contents may also be; for example, motion picture data representing a motion picture, image data representing a still image, a computer program, and the like.

In the above embodiment, descriptions are provided while the speaker terminal 10 that reproduces audio data is taken as a contents reproducing terminal for reproducing contents. However, the contents reproducing terminal is not limited to the speaker terminal and may also be a device having display equipment (a liquid-crystal display or the like) that reproduces and outputs a motion picture, a computer that executes a game program, and the like. In short, the contents reproducing terminal may be any device, so long as the device can reproduce contents, such as audio data, motion picture data, still image data, a computer program, and the like.

(2) In the above-mentioned embodiment, the contents distribution management table storage area 423 is provided, and the table is updated in accordance with specifics of the request data. However, the present invention is not limited to this embodiment. For instance, the center unit 40 may receive, from the contents reproducing terminal, request data showing a request for acquisition of contents; read from the contents database contents corresponding to the received request data; and transmit, as a response to the request data, the thus-read contents to the contents reproducing terminal.

(3) In the foregoing embodiment, the computer 50 transmits request data to the center unit 40. However, the contents reproducing terminal, such as the speaker terminal 10, may also transmit request data to the center unit.

(4) In the embodiment, the center unit 40 is configured so as to generate collation data by analysis of contents. However, a device for generating collation data is not limited to the center unit, and a contents reproducing terminal, such as a speaker terminal, may also generate collation data. In this case, when received contents, the contents reproducing terminal analyzes received contents, to thus generate collation data, and transmits the thus-generated collation data to the collator. The collator specifies contents by use of the received collation data and transmits data showing the thus-specified contents to the center unit 40. The center unit 40 determines whether or not to allow reproducing of the contents on the basis of the received label data and transmits data showing a result of determination to the speaker terminal 10. When the data transmitted from the center unit 40 showing allowance of reproducing, the speaker terminal 10 reproduces the contents. In contrast, in other cases, the speaker terminal 10 discards the received contents just as they are without reproducing the contents. In this case, the speaker terminal 10 preferably buffers the received contents in a predetermined buffer area until the collator completes collation processing.

(5) In the foregoing embodiment, there is adopted a configuration in which contents are stored in the contents database storage area 421 of the center unit 40. In lieu of this, there may also be adopted a configuration in which a contents database storing contents and the center unit 40 are connected with each other for communication. In this case, the essential requirement for the center unit 40 is to acquire from the contents database contents to be supplied to the speaker terminal 10 and distribute the thus-acquired contents to the speaker terminal 10.

(6) In the above embodiment, the center unit 40 acquires request data by receiving request data transmitted from the computer 50. However, the manner of acquisition of request data is not limited to this way. For instance, the user may also operate the operation section 44 of the center unit 40, to thus input request data. In this case, the operation section 44 outputs an operation signal responsive to operated contents to the control section 41, and the control section 41 acquires request data in accordance with an operation signal supplied from the operation section 44. In short, any mode for inputting request data into the control section 41 is acceptable.

In the above embodiment, the request data are configured in such a way that the items “Time Zone,” “Music Title, Genre,” and “Location in Store” are associated with each other. However, in place of such a configuration, there may also be used a request data configured in such a way that the items “Time Zone” and “Store” are associated with each other for the case of a store 100 where only one speaker terminal 10 is installed. In short, any data configuration is accepted, so long as the speaker terminal 10 serving as a destination is specified by reference to one or a plurality of tables.

In the foregoing embodiment, conditions showing the type of a genre, a creator of contents, the name of a singer, and a group to which contents belong (a new song, a best song, or the like) are used as conditions for selecting contents. However, conditions for selecting contents are not limited to those mentioned above, and any conditions for selecting contents may also be acceptable.

(7) In the above embodiment, the center unit 40 and the speaker terminal 10 are configured so as to be connected with each other for communication by way of the network 2, the PLC-specific adapter 30, and the power line 1. In place of such a configuration, there may also be adopted a configuration in which the center unit 40 and the speaker terminal 10 are connected with each other for communication by way of a power line. On this occasion, the center unit 40 transmits the audio data to the speaker terminal 10 by way of the power line according to the PLC scheme, and the audio data transmitted from the center unit 40 are received by the speaker terminal 10. In this case, the center unit 40 and the speaker terminal 10 directly transmit data through the power line, and hence the PLC-specific adapter 30 is not needed. As mentioned above, the center unit 40 and the speaker terminal 10 may also be connected with each other for communication through the power line. Alternatively, they may also be connected through a network, such as the Internet. In short, the minimum requirement is that the center unit 40 and the speaker terminal 10 be connected with each other for communication.

(8) In the above embodiment, the center unit 40 may also compute a charge for contents from management information or transmission records stored in the contents distribution management table. Specifically, for instance, upon detection of a predetermined time and date (e.g., the end of a month, a week end, and the like) having come, the center unit 40 computes a charge for contents from management information or a transmission log stored in the distribution management table. The center unit 40 outputs charge data showing the thus-computed charge to; for instance, the computer 50. An administrator of the computer 50 can ascertain a charge for contents by checking charge data transmitted from the center unit 40. Specifically, according to this mode, the center unit 40 performs processing for computing a charge in conjunction with processing for distributing contents. Hence, the user of the system does not need to compute a charge for contents and perform laborious operation.

During charging operation, the center unit 40 reduces an amount billed by means of the mark “Discount music, Charge-of-free music.” Specifically, for instance, when played contents are not for promoting reproducing, the control section 41 may perform processing for charging contents in accordance with a normal charge system (a first charge system). In contrast, when the played contents are for promoting reproducing, the control section may also perform processing for charging contents in accordance with a charge system differing from a normal charge system (a second charge system) (e.g., operation for rendering an amount billed cheaper than that for other contents, discounting an amount billed for another contents, and the like).

The center unit 40 may also count records of transmission of contents or charges for contents on a per-client basis. Specifically, for instance, the center unit may also compute charges for distributed contents for each contract store. Processing for counting records of transmission of contents or charges for contents may also be performed on a per-store basis or on a per-speaker basis.

(9) In the above embodiment, the center unit 40 may also count the logs in connection with how many sales promotion contents have been distributed to which store and report results of summation to a copyright holder. In this case, the control section 41 of the center unit 40 may also summate, on a per-contents basis, the number of times sales promotion contents distributed through streaming distribution and output data representing a summation result. Specifically, for instance, data representing a result of summation may also be transmitted to a copyright holder by means of an electronic mail, or the like, thereby reporting the result of summation to the copyright holder of contents.

As shown in FIG. 8, in the present embodiment, a list of sales promotion contents is displayed on a display section 43 (“Campaign Music of This Month” in FIG. 8, or the like). However, the mode for reporting sales promotion contents is not limited to displaying of the list. The sales promotion contents may also be reported by means of transmission of; for example, an electronic mail.

In the foregoing embodiment, when a predetermined time zone comes, the center unit 40 may also automatically distribute sales promotion contents regardless of specifics of the distribution management table. In this case, the sales promotion contents are automatically reproduced by the speaker terminals 10 in a predetermined time zone. Moreover, at a point in time when streaming-distribution of a predetermined number of contents (e.g., ten pieces of music, and the like) is completed, sales promotion contents may also be distributed in an interrupting manner. In this case, contents for one piece of music are distributed after reproducing of a predetermined number of contents desired to be distributed by a manager of a store, or the like. Thus, when predetermined conditions (the number of contents to be distributed, a time, and the like) are fulfilled, the center unit 40 may also automatically distribute sales promotion contents to the speaker terminals 10 through streaming distribution.

(10) The center unit 40 of the foregoing embodiment may also be built by connection of two or more devices through a communications network. For instance, the center unit may also be configured as a system in which a custom-designed center unit having a function of distributing contents, or the like, and a custom-designed charging device that computes charges for contents are connected for communication through a communications network, or the like.

(11) A program executed by the control section 41 of the center unit 40 or the CPU 105 of the speaker terminal 10 of the embodiment can also be provided as being recorded in a recording medium, such as a magnetic tape, a magnetic disk, a flexible disk, an optical recording medium, a magneto-optical recording medium, RAM, ROM, and the like. Further, the program can also be downloaded to the center unit 40 or the speaker terminal 10 through a network such as the Internet.

What is claimed is:

1. A contents distribution system comprising:
a center unit; and
a plurality of contents reproducing terminals communicating with the center unit,
wherein the center unit includes:
a memory that stores contents identifying information for identifying contents and promotion information showing whether or not to promote reproducing of contents while the contents identifying information is associated with the promotion information;
a request data receiver that receives request data showing a request for distribution of contents to the contents reproducing terminal;
a distribution contents selector that, when the received request data shows a request for distribution of contents promoted by reproducing, selects one or a plurality of contents showing that the corresponding promotion information promotes reproducing of contents, with reference to the memory; and
a contents distributor that reads the one or the plurality of selected contents from a predetermined storage device and distributes the read contents to the contents reproducing terminal corresponding to the received request data, and
wherein the contents reproducing terminal includes:
a contents receiver that receiving contents distributed from the center unit by the contents distributor; and
a reproducing unit that reproduces contents received from the contents receiver.

2. The contents distribution system according to claim 1, wherein the contents receiver receives contents transmitted from the center unit by extracting a signal superimposed on electric power transmitted by way of a power line.

3. A center unit comprising:
a memory that stores contents identifying information for identifying contents and promotion information showing whether or not reproducing of the contents is promoted while the contents identifying information is associated with the promotion information;
a request data receiver that receives request data showing request for distribution of contents to a contents reproducing terminal;
a distribution contents selector that, when the received request data show a request for distribution of contents for promoting by reproducing, selects one or a plurality of contents showing that corresponding promotion information promotes reproducing of contents, with reference to the memory; and
a contents distributor that reads from a predetermined storage device one or a plurality of selected contents from a predetermined storage device and distributes the read contents to a contents reproducing terminal corresponding to the received request data.

4. The center unit according to claim 3, further comprising:
a charge controller that subjects contents distributed by the contents distributor to charging operation at amounts corresponding to the respective contents.

5. The center unit according to claim 4, wherein
the memory stores one or a plurality of groups, each group including one or a plurality of contents, and
the center unit further comprises a determination unit that determines whether or not the received request data shows a request for distribution of contents belonging to the groups; and
the charge controller performs charging corresponding to a predetermined charging condition individually set for the respective groups when a result of determination made by the determination unit is affirmative.

6. The center unit according to claim 4, wherein
the charge controller includes:
a first charging unit that performs processing for charging for the contents in accordance with a first charging system; and
a second charging unit that performs processing for charging for the contents in accordance with a second charging system which is cheaper in charge than the first charging system, and
charging operation is performed by use of the second charging unit when promotion information corresponding to contents which are objects of computation of a charge shows promotion of reproducing, and charging operation is performed by use of the first charging unit in other cases.

7. The center unit according to claim 3, wherein, when the received request data show a predetermined selection condition, the distribution contents selector selects contents satisfying the selection condition with reference to the memory in such a manner that the number of contents corresponding to promotion information showing promotion by reproducing becomes greater than the number of other contents.

8. The center unit according to claim 7, wherein the selection condition indicates at least any one of a type of genre, a creator of a contents, a name of a singer, and a group to which a contents belongs.

9. The center unit according to claim 3, further comprising:
a reader that reads contents identifying information showing that corresponding promotion information promotes reproducing of a contents, with reference to the memory; and
a notification unit that notifies contents indicated by the contents identifying information read by the reader.

10. A center unit comprising:
a memory that stores contents identifying information for identifying contents and promotion information showing whether or not reproducing of contents is promoted while the contents identifying information is associated with the promotion information;
a request data receiver that receives request data showing a request for distribution of contents to the contents reproducing terminal;
a distribution contents selector that, when the received request data shows a predetermined condition for selection, selects contents corresponding the promotion information showing promotion of reproducing, with reference to the memory; and
a contents distributor that reads the selected contents from a predetermined storage device and distributes the read contents to a contents reproducing terminal corresponding to the received request data.

11. The center unit according to claim 10, wherein, when the received request data show the predetermined selection condition, the distribution contents selector selects contents satisfying the selection condition with reference to the memory in such a manner that the number of contents corresponding to promotion information showing promotion by reproducing becomes greater than the number of other contents.

12. The center unit according to claim 10, wherein the selection condition indicates at least any one of a type of genre, a creator of a contents, a name of a singer, and a group to which a contents belongs.

13. The center unit according to claim 10, further comprising:
a reader that reads contents identifying information showing that corresponding promotion information promotes reproducing of a contents, with reference to the memory; and
a notification unit that notifies contents indicated by the contents identifying information read by the reader.
